(19) United States
(12) Patent Application Publication
(10) Pub. No.: US 2026/0285263 A1
(43) Pub. Date: Sep. 24, 2026

(54) DRIVING CONTROL DEVICE AND VEHICULAR SYSTEM

(71) Applicant: DENSO CORPORATION, Kariya-city (JP)

(72) Inventors: Kiyokazu TAKAGI, Kariya-city (JP); Yuta MATSUMOTO, Kariya-city (JP); Ryozo YAMASHITA, Kariya-city (JP); Ryoma NIIHARA, Kariya-city (JP)

(21) Appl. No.: 19/687,742

(22) Filed: May 26, 2026

Related U.S. Application Data
(63) Continuation of application No. PCT/JP2024/040696, filed on Nov. 15, 2024.

(30) Foreign Application Priority Data
Nov. 27, 2023 (JP) 2023-200004

(51) Int. Cl. B60T 7/04

(52) U.S. Cl. CPC B60T 7/042; B60T 2210/20; B60T 2220/04; B60T 2250/02; B60T 2270/60

(57) ABSTRACT

In a driving control device for controlling driving of a vehicle, a controller is configured to acquire, from a contactless sensor mounted to the vehicle, sensor information indicative of a motion of a target foot of a driver of the vehicle, and recognize, based on the sensor information, the motion of the target foot of the driver. The controller is configured to control a braking operation of the vehicle based on the recognized motion of the target foot of the driver so as to improve energy efficiency of the vehicle.

### CROSS REFERENCE TO RELATED APPLICATION

This application is a bypass continuation application of currently pending international application No. PCT/JP2024/040696 filed on Nov. 15, 2024 designating the United States of America, the entire disclosure of which is incorporated herein by reference, the international application being based on and claiming the benefit of priority from Japanese Patent Application Publication No. 2023-200004 filed on Nov. 27, 2023, the disclosure of which is incorporated in its entirety herein by reference.

### TECHNICAL FIELD

The present disclosure relates to a driving control device and a vehicular system that includes the driving control device.

### BACKGROUND

Japanese Patent Application Publication No. 2014-193665 provides a vehicle control apparatus capable of performing vehicle control and driving assistance early and rapidly. The vehicle control apparatus includes a determination unit and a control unit.

The determination unit determines whether a driver's foot is in close proximity to any of the pedals of a vehicle. Specifically, the determination unit determines whether the driver's foot is in close proximity to any of a brake pedal, a clutch pedal, and an accelerator pedal, based on whether short-range communication has been established between an IC tag mounted to a shoe of the driver and a radio wave receiver mounted to each of the pedals.

When it is determined that the driver's foot is in close proximity to any pedal of the vehicle, the control unit executes preparatory operations prior to control operations triggered by depression of the pedal. The preparatory operations for the brake pedal include, for example, lighting of a brake lamp of the vehicle and starting pressurization of a brake master cylinder of a brake system of the vehicle for braking preparation. The preparatory operations for the clutch pedal include, for example, stroke assistance of the clutch pedal.

### SUMMARY

Such a vehicle control apparatus aims to properly reflect the driver's intention on the driving assistance and improve energy efficiency, i.e., fuel efficiency and/or electric efficiency to thereby improve the user convenience of the vehicle in which the vehicle control apparatus is installed.

From this viewpoint, the determination unit of the vehicle control apparatus disclosed in the patent publication determines whether the driver's foot is in close proximity to any of the brake pedal, the clutch pedal, and the accelerator pedal, based on radio waves transmitted from the IC tag mounted to the shoe of the driver.

Accordingly, the vehicle control apparatus disclosed in the patent publication still left room for improvement in terms of user convenience.

The present disclosure has been made in view of the above-described circumstances. Specifically, the present disclosure provides a technology that enables, for example, promptly and appropriately reflecting a driver's intention in driving assistance while improving energy efficiency.

An aspect of the present disclosure provides a driving control device for controlling driving of a vehicle. The driving control device includes a controller.

The controller is configured to acquire, from a contactless sensor mounted to the vehicle, sensor information indicative of a motion of a target foot of a driver of the vehicle, and recognize, based on the sensor information, the motion of the target foot of the driver. The controller is configured to control a braking operation of the vehicle based on the recognized motion of the target foot of the driver so as to improve energy efficiency of the vehicle.

Note that each parenthesized reference character assigned to a corresponding element in the present disclosure merely represents an example of a relationship between the corresponding element and a corresponding specific element described in an present embodiment described later, and therefore the present disclosure is not limited to the parenthesized reference characters.

### BRIEF DESCRIPTION OF THE DRAWINGS

Other aspects of the present disclosure will become apparent from the following description of embodiments with reference to the accompanying drawings in which:

FIG. 1 is a schematic side view illustrating the interior of a vehicle equipped with a vehicular system;

FIG. 2 is an oblique perspective view illustrating a driver's footwell illustrated in FIG. 1;

FIG. 3 is a block diagram illustrating a schematic configuration of the vehicular system of a present embodiment;

FIG. 4 is a schematic view illustrating how a driver's foot moves detectable by a foot motion sensor illustrated in FIG. 3; and

FIG. 5 is a schematic view illustrating how the driver's foot moves detectable by the foot motion sensor illustrated in FIG. 3.

### DETAILED DESCRIPTION OF EMBODIMENTS

The following describes a present embodiment of the present disclosure with reference to the accompanying drawings. Note that descriptions of various modifications applicable to the present embodiment are collectively provided after the series of descriptions related to the present embodiment, as inserting them in the middle of the descriptions may hinder understanding of the present embodiment.

### Schematic Configuration of Vehicle

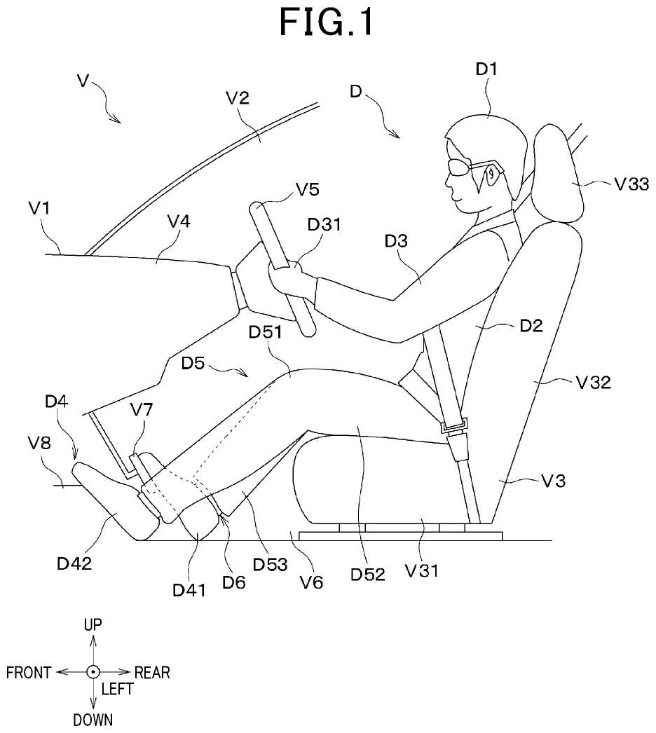

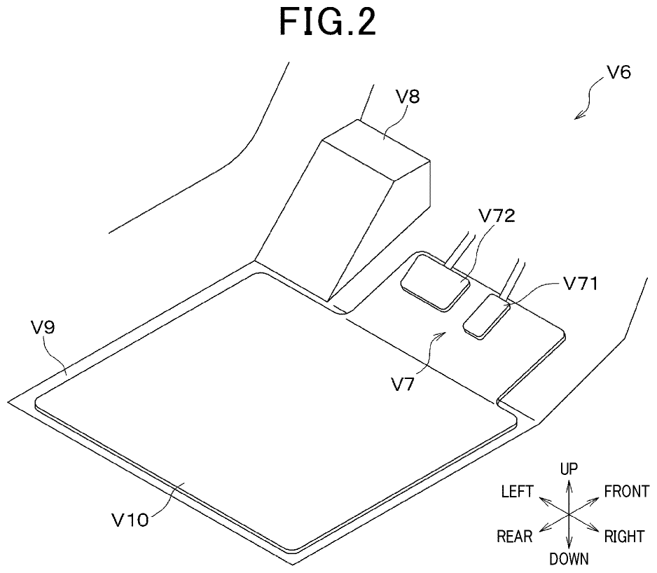

Referring to FIG. 1, a vehicle V according to the present embodiment is so-called passenger vehicle and has a body V1 having a substantially box shape. For simplification of description, directional concepts of “front”, “rear”, “up”, “down”, “right”, and “left” are defined as shown in FIGS. 1 and 2. “Down” is the same direction as the direction of gravitational action when the vehicle V is stably placed on a horizontal plane in a drivable state, and “up” is the opposite direction thereof. That is, a vertical direction, i.e., an up-down direction, is a direction parallel to the direction of gravitational action when the vehicle V is stably placed on a horizontal plane in a drivable state.

“Front” is a traveling direction when the vehicle V travels forward in a straight line on a horizontal plane, and “rear” is the opposite direction thereof. “Right” is the positive X-axis direction in a right-handed XYZ coordinate system where the positive Z-axis direction is “up” and the positive Y-axis direction is “front”, and “left” is the opposite direction thereof.

A plurality of occupant seats including a driver's seat V3 are provided in a vehicle interior V2, which is an internal space of the vehicle body V1. An occupant who boards the driver's seat V3 is hereinafter referred to as a driver D. The driver's seat V3 includes a seat cushion V31 having a seating surface for the driver D, a seat back V32 that supports the driver D from behind, and a headrest V33.

A dashboard V4 is disposed in front of the driver's seat V3. A steering wheel V5 for steering the vehicle V is mounted to the dashboard V4 so as to project from the dashboard V4 toward the driver's seat V3.

Pedals V7 and a footrest V8 are provided in a footwell space V6, which is a space defined below the dashboard V4. As shown in FIG. 2, the pedals V7 include an accelerator pedal V71 and a brake pedal V72.

The accelerator pedal V71 and the brake pedal V72 are disposed such that the accelerator pedal V71 is located on the right side of the brake pedal V72. The footrest V8 is disposed on the left side of the brake pedal V72. That is, the accelerator pedal V71, the brake pedal V72, and the footrest V8 are arranged in this order from right to left. A floor V9 of the vehicle body V1 defines the bottom of the footwell space V6, and a floor mat V10 is laid on the floor V9.

FIG. 1 illustrates a state in which the driver D is seated in the driver's seat V3 in a driving posture. The “driving posture” refers to a proper seating posture of the driver D on the driver's seat V3, in which the driver D can accurately operate the steering wheel V5 and the pedals V7. In such a driving posture, the head D1 of the driver D is supported from behind by the headrest V33, and the torso D2 of the driver D is in close contact with the seat back V32. The arms D3 of the driver D extend forward while their elbows are slightly bent, and the hands D31 of the driver D grip the steering wheel V5. The feet D4 of the driver D are defined as parts of the legs D5 beyond their ankles D6. The right foot D41 of the feet D4 is positioned to operate the pedals V7, and the left foot D42 of the feet D4 is typically placed on the footrest V8.

That is, the vehicle V in the present embodiment is configured as a so-called automatic vehicle or semi-automatic vehicle that does not require a clutch operation by the left foot D42 of the driver D. The thighs D52 are defined as parts of the driver's legs D5 proximal to the knees D51 thereof. Most of the thighs D52 are in close contact with the seat cushion V31. The shins D53, which are parts between the feet D4 and the knees D51 of the legs D5, are positioned to extend diagonally forward and downward from the knees D51 so as to facilitate operation and switching of the pedals V7 with the right foot D41.

### Overall Configuration of Vehicular System

The vehicle V includes a vehicular system 1 installed therein. The vehicle V will also be referred to as a host vehicle V. The vehicular system 1, which is installed in the host vehicle V, is configured to serve as a driving automation system or an autonomous driving system in the system-installed vehicle V. The autonomous driving system is configured to implement, as a driving automation level, at least one of SAE levels (0 to 5 levels) defined in the SAE J3016 standard by SAE international; SAE is an abbreviation for “Society of Automotive Engineers”.

Level X in SAE J3016 is hereinafter simply referred to as “SAE level X”.

The “driving automation level” can be set to at least one of the SAE levels 0 to 5. The driving automation level may be higher as the SAE level X set as the driving automation level may be higher. An increase in the dynamic driving tasks to be performed by the autonomous driving system may result in an increase in the driving automation level. The driving automation level increases as the corresponding SAE level increases.

Similarly, the driving automation level may be lower as the SAE level X set as the driving automation level may be lower. A decrease in the dynamic driving tasks to be performed by the autonomous driving system may result in a decrease in the driving automation level. The driving automation level decreases as the corresponding SAE level decreases.

Accordingly, the driving automation level may increase or decrease due to an increase or decrease in the dynamic driving tasks to be performed by the autonomous driving system even while the driving automation level remains within the same SAE level (e.g., within SAE level 1 or 2).

SAE levels 0 to 5 will be specifically described below.

Hereinafter, the driver D is an occupant who manages and carries out the dynamic driving tasks. The dynamic driving tasks show all operational functions and all maneuver functions that need be carried out in real time by the driver D when the driver D drives the host vehicle V in traffic roads, except for strategical functions. Overall driving actions can be categorized into the operational functions, maneuver functions, and strategical functions.

The strategical functions may include functions of planning a travel schedule and selecting one or more places through the planned travel schedule. Specifically, the strategical functions may include functions of determining or selecting a travel schedule that shows (i) whether to go to a destination, (ii) when to go to the destination, and (iii) how to go to the destination.

The maneuver functions may include functions of determining, in various traffic situations, various maneuvers that may include, during the scheduled travel, (i) determining whether and when to overtake, (ii) determining whether and when to make a lane change, and (iii) checking the mirrors.

The operational functions may include driver's instantaneous reactions, such as steering operations, braking operations, accelerating operations, and/or minor adjustments of these operations, in order to keep a position of the host vehicle V in a corresponding lane of a road and/or avoid at least one obstacle and/or at least one dangerous event on the path of the moving host vehicle V.

OEDR is an abbreviation for “Object and Event Detection and Response”, and can be called “detection and response of objects and events”. OEDR includes the monitoring of driving environment around the host vehicle V. The monitoring of the driving environment around the host vehicle V may include detection, recognition, and classification of one or more objects and/or events. The monitoring of the driving environment around the host vehicle V may additionally include preparation of response for the one or more objects and/or events. Operational Design Domain (ODD) conditions, which will also be called “specific domain conditions”, represent specific conditions under which a given autonomous driving system or feature thereof is designed to function. The ODD conditions may include, for example, at least one of a plurality of limiting conditions including, for example, geographic conditions, environmental conditions, velocity conditions, and time conditions.

SAE level 0 represents No Autonomous driving, which represents that the driver D performs all the dynamic driving tasks.

SAE level 1 represents Driving Assistance, which represents that an autonomous driving system sustainably executes, under specific ODD conditions, either the lateral vehicle motion control subtasks or the longitudinal vehicle motion control subtasks of the dynamic driving tasks. The longitudinal vehicle motion control subtasks include, for example, forward/backward operation, acceleration/deceleration operation, and stop operation. The lateral vehicle motion control tasks include, for example, steering operation. In particular, the autonomous driving system is configured not to perform simultaneously both the lateral vehicle motion control subtasks and the longitudinal vehicle motion control subtasks.

SAE level 2 represents Advanced Driving assistance, which represents that an autonomous driving system sustainably executes, under specific ODD conditions, both the lateral vehicle motion control subtasks and the longitudinal vehicle motion control subtasks of the dynamic driving tasks with expectation that the driver D completes OEDR subtasks and supervises the autonomous driving system.

SAE level 3 represents Conditional Autonomous driving, which represents that a driving automatic system sustainably executes, under specific ODD conditions, all the dynamic driving tasks. Under the specific ODD conditions, the driver D is not required to perform one of the OEDR subtasks of monitoring the traffic environment around the host vehicle V, but, when the driving automatic system has a difficulty continuing at SAE level 3, the driving automatic system requests the driver D to control the host vehicle V with plenty of time, so that the driver D needs to smoothly respond to the request.

SAE level 4 represents High Automation, which represents that a driving automatic system sustainably executes, under specific ODD conditions, all the dynamic driving tasks. When the driving automatic system has a difficulty continuing at SAE level 4, the driving automatic system addresses the difficulty.

SAE level 5 represents Full Automation, which represents that a driving automatic system on the host vehicle V sustainably executes all the dynamic driving tasks without limitation in all the ODD conditions. When the driving automatic system has a difficulty continuing at SAE level 5, the driving automatic system addresses the difficulty without limitation in all the ODD conditions.

The driving automation level may be higher as the SAE level X set as the driving automation level may be higher. An increase in the dynamic driving tasks to be performed by the autonomous driving system may result in an increase in the driving automation level. The driving automation level increases as the corresponding SAE level increases.

Similarly, the driving automation level may be lower as the SAE level X set as the driving automation level may be lower. A decrease in the dynamic driving tasks to be performed by the autonomous driving system may result in a decrease in the driving automation level. The driving automation level decreases as the corresponding SAE level decreases.

Accordingly, the driving automation level may increase or decrease due to an increase or decrease in the dynamic driving tasks to be performed by the autonomous driving system even while the driving automation level remains within the same SAE level (e.g., within the SAE level 1 or 2).

The host vehicle V of the present embodiment is configured to be able to execute various tasks included in the driving automation level, which is set to any one of the SAE levels 1 to 4, depending on a traveling situation and a selection operation of the driver D. That is, the vehicular system 1, which is installed in the host vehicle V, is configured to function as an autonomous driving system for the host vehicle V. The vehicular system 1 is configured to be able to execute various types of driving control during driving of the host vehicle V and various types of notification or warning operations accompanying the driving control. Specifically, the vehicular system 1 is configured to be able to execute autonomous driving of the SAE level 3 or 4, advanced driving support of the SAE level 2, and various types of ADAS-related control included in the SAE level 1. ADAS is an abbreviation for Advanced Driver-Assistance Systems. Thus, the vehicular system 1 according to the present embodiment may be referred to as an “autonomous driving system” while the autonomous driving of the SAE level 3 or 4 is being executed. Hereinafter, in the present specification, autonomous driving of the SAE level 3 or 4 is simply referred to as “autonomous driving” unless otherwise specified.

The advanced driving assistance that can be carried out by the vehicular system 1 of the present embodiment may include hands-off driving. The hands-off driving enables the vehicular system 1 to automatically move the host vehicle V forward or backward, steer the host vehicle V, accelerate or decelerate the host vehicle V, make lane changes of the host vehicle V, and/or stop the host vehicle V as long as the driver D addresses appropriately any intervening requests and other requests issued from the vehicular system 1.

Hands-off driving requests the driver D to monitor road conditions around the host vehicle V, traffic situations around the host vehicle V, and information about whether there are one or more obstacles around the host vehicle V without requesting the driver D to be in a hands-on state. The hands-on state represents a state of the driver D in which the driver D is ready to steer the host vehicle V, i.e., ready to intervene in the lateral vehicle motion control subtasks. The hands-on state typically represents a state of the driver D in which the driver D is sitting in the driver's seat V3 with the driving posture and is ready to properly operate the steering wheel V5 and the pedals V7. The driver D being in the hands-on state generally grasps the steering wheel V5 with the hands D31. The hands-on state also applies to the state in which the driver D touches the steering wheel V5 with the hands D31 while being ready to grasp the steering wheel V5. “Obstacles” are objects that the host vehicle V should avoid colliding with, and include other vehicles, pedestrians, persons lying down, buildings, barricades, poles, cones, and other various types of objects. “Other vehicles” include cyclists, i.e., two-wheeled or three-wheeled vehicles with occupants.

During autonomous driving, a leg-on state is not required and a leg-off state is permitted. Similarly, depending on the content of advanced driving assistance being executed, the leg-on state is not required and the leg-off state is permitted.

The “leg-on state” refers to a state in which one of the feet D4 of the driver D in the driving posture is placed at a position where any one of the pedals V7 can be immediately depressed, and typically refers to a state in which the right foot D41 is placed on any one of the pedals V7. The “leg-on state” includes a state in which one of the feet D4 of the driver D is depressing any one of the pedals V7 and a state in which one of the feet D4 is not depressing but is lightly touching any one of the pedals V7.

In contrast, the “leg-off state” refers to a state in which one of the feet D4 of the driver D is not placed at a position where any pedal V7 can be immediately depressed, and typically refers to a state in which the right foot D41 is not placed on any pedal V7. Specifically, for example, during the execution of ACC (which is an abbreviation for Adaptive Cruise Control), during hands-off driving, or during autonomous driving, the leg-off state is permitted. That is, during the execution of ACC, during hands-off driving, or during autonomous driving, the driver D can place the right foot D41 in front of or to the right of the accelerator pedal V71, or raise the right foot D41 upward using an ottoman (not shown).

ACC is configured to perform (i) cruise control for causing the host vehicle V to travel for maintaining a constant target speed when no preceding vehicle exists in front of the host vehicle V, and (ii) following control for causing, when a preceding vehicle is present in front of the host vehicle V, the host vehicle V to travel while following the preceding vehicle at controlled speeds that are equal to or lower than the target speed.

### Configuration of Vehicular System

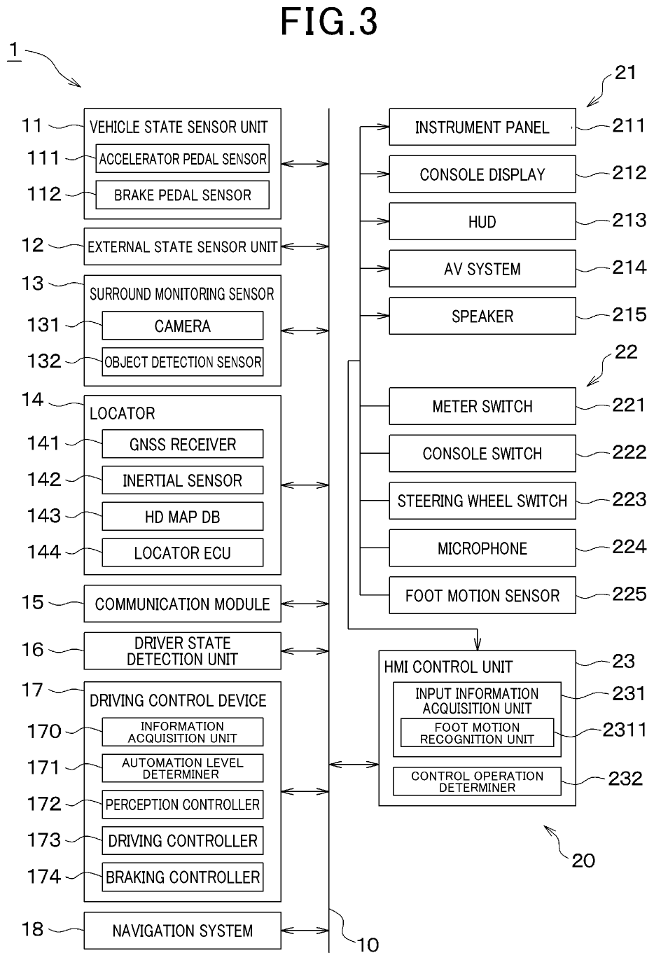

As illustrated in FIG. 3, the vehicular system 1 has a configuration as an in-vehicle network including an in-vehicle communication network 10 and a plurality of nodes and the like connected to each other via the in-vehicle communication network 10. The in-vehicle system 1 is configured to comply with a predetermined communication standard such as CAN®. CAN® is an abbreviation for Controller Area Network.

The vehicular system 1 includes a vehicle state sensor unit 11, an external state sensor unit 12, a surround monitoring sensor unit 13, a locator 14, a communication module 15, a driver state detection unit 16, a driving control device 17, a navigation system 18, and an HMI system 20. HMI is an abbreviation for Human Machine Interface.

The HMI system 20 includes an output unit 21, an input unit 22, and an HMI control unit 23, i.e., HCU 23. The components 11 to 20 from the vehicle state sensor unit 11 to the HMI system 20 are connected to the in-vehicle communication network 10. The output unit 21 and the input unit 22 are connected to the HMI control unit 23.

### Various Sensors

The vehicle state sensor unit 11 is configured to generate an output signal corresponding to each of various driving-state parameters of the host vehicle V. The “various driving-state parameters” include, for example, driving-operational state parameters by the driver D or the autonomous driving system, such as an opening degree of the accelerator, the operation quantity of the brake, the position of the shift lever, and an operation angle of the steering. Additionally, the “various driving-state parameters” include, for example, physical parameters related to the behavior of the host vehicle V, such as the speed of the host vehicle V, the angular velocity of the host vehicle V, the longitudinal acceleration of the host vehicle V, and the lateral acceleration of the host vehicle V.

Specifically, the vehicle state sensor unit 11 include well-known sensors that are necessary for vehicle driving control, such as a steering angle sensor, a speed sensor for each wheel, an angular velocity sensor, and longitudinal and lateral acceleration sensors in addition to an accelerator pedal sensor 111 and a brake pedal sensor 112. The vehicle state sensor unit 11 is configured to provide, via the in-vehicle communication network 10, generated output signals of the various driving-state parameters to each of predetermined components of the host vehicle V, such as the driving control device 17.

The external state sensor unit 12 is configured to generate an output signal corresponding to various natural-environmental parameters included in driving-environment parameters surrounding the host vehicle V. The “various natural-environmental parameters” include, for example, physical parameters such as an outside temperature, an amount of rainfall, and illuminance.

Specifically, the external state sensor unit 12 is a generic term, which includes well-known sensors such as an outside temperature sensor, a raindrop sensor, and an illuminance sensor for simplification of illustration and description. The external state sensor unit 12 is configured to provide, via the in-vehicle communication network 10, generated output signals of the various natural-environmental parameters to each of the predetermined components of the host vehicle V, such as the driving control device 17.

The surround monitoring sensor unit 13 is configured to detect surrounding parameters included in the driving-environment parameters other than the natural-environmental parameters detectable by the external state sensor unit 12. Specifically, the surround monitoring sensor unit 13 is configured to be capable of detecting moving objects and stationary objects in a predetermined detection region around the host vehicle V.

“Moving objects” include pedestrians, cyclists, animals, and other traveling vehicles. “Stationary objects” include fallen objects on a road, guardrails, curbs, parked vehicles, road signs, road markings, and roadside structures (e.g., walls, buildings, etc.). The surround monitoring sensor unit 13 may also be referred to as an “ADAS sensor unit”.

The surround monitoring sensor unit 13 of the present embodiment includes one or more cameras 131 and one or more object detection sensors 132 as components for monitoring and detecting moving objects and stationary objects.

The one or more cameras 131 are arranged to capture images around the host vehicle V. Each camera 131 of the present embodiment is a digital camera device and includes an image sensor such as a CCD or a CMOS image sensor. CCD is an abbreviation for Charge Coupled Device. CMOS is an abbreviation for Complementary Metal-Oxide-Semiconductor.

Each object detection sensor 132 is a millimeter-wave radar sensor, a submillimeter-wave radar sensor, or a laser radar sensor that transmits and receives radar waves, and is mounted to a corresponding front portion of the vehicle body V1 in the host vehicle V. Each object detection sensor 132 is configured to output a signal corresponding to the position and relative speed of each reflection point. The “reflection point” is a point on the surface of an object existing around the host vehicle V, at which transmitted radar waves from an object detection sensor 132 are estimated to have been reflected to produce reflected waves (echoes). The “relative speed of a reflection point” is a speed of the reflection point relative to the host vehicle V; that is, a relative speed of an object corresponding to the reflection point with respect to the host vehicle V.

### Locator

The locator 14 is configured to acquire, for example, highly accurate position information about the host vehicle V using so-called complex positioning. Specifically, the locator 14 is comprised of a GNSS receiver 141, an inertial sensor 142, a high-definition (HD) map database (DB) 143, and a locator ECU 144.

The GNSS is an abbreviation for Global Navigation Satellite System, and the highly accurate position information about the host vehicle V is positional information on the host vehicle V, which has at least a position accuracy usable by the advanced driving assistance in the SAE level 2 or more, in other words, a position accuracy with an error of lower than or equal to 10 cm.

The GNSS receiver 141 is configured to receive navigation signals transmitted from a plurality of positioning satellites, that is, a plurality of artificial satellites. In particular, the GNSS receiver 141 is configured to be capable of receiving the navigation signals from a positioning satellite included in at least one GNSS selected from the GPS, the QZSS, the GLONASS, the GLONASS, the Galileo, the IRNSS, and the Beidou Navigation Satellite System. GPS is an abbreviation for Global Positioning System, QZSS is an abbreviation for Quasi-Zenith Satellite System, GLONASS is an abbreviation for Global Navigation Satellite System, and IRNSS is an abbreviation for Indian Regional Navigation Satellite System.

The inertial sensor 142 is configured to detect (i) three-axes accelerations acting on the host vehicle V and (ii) angular velocities acting on the host vehicle V around the respective three axes. For example, the locator 14 has a substantially box-shaped housing, and the inertial sensor 142 is comprised of a three-axis accelerometer and a three-axis gyro sensor installed in the housing.

The HD map DB 143 is comprised of mainly one or more non-volatile rewritable memories, and is configured to store HD map information to be rewritable while holding the stored HD map information even if power supplied to the HD map database 143 is shut off. The non-volatile rewritable memories include, for example, a hard disk drive, an Electronically Erasable and Programmable Read Only Memory (EEPROM), and a flash ROM.

The HD map information, which will also be referred to as HD map data, includes higher-definition map information having a positional error lower than or equal to an error of approximately several meters of the map information stored in the navigation system 18.

Specifically, the HD map information DB 143 for example stores, as the HD map information, map information available by autonomous driving of the SAE level 2 or more, which includes, for example, (i) information about three-dimensional road shapes, (ii) information about the number of lanes in each road, and (iii) information about road traffic regulations. The HD map information is stored in the HD map information DB 143 to be in conformity with a predetermined standard, such as ADASIS.

The locator ECU 144 includes a vehicular microcomputer comprised of a Central Processing Unit (CPU), a ROM, a Random Access Memory (RAM), an input/output (I/O) interface, and other peripheral devices. The locator ECU 144 is configured to sequentially calculate the current position and/or the current azimuth of the host vehicle V in accordance with (i) the navigation signals received by the GNSS receiver 141, (ii) the accelerations and angular velocities detected by the inertial sensor 142, and (iii) the speed of the host vehicle V acquired from the vehicle state sensor unit 11. The locator 14 is configured to provide, to each of the predetermined components of the host vehicle V, such as the driving control device 17 and/or the HMI control unit 23, the calculation results, i.e., the current position and/or the current azimuth of the host vehicle V sequentially calculated by the locator ECU 144.

### Communication Module

The communication module 15, which will also be referred to as a Data Communication Module (DCM) 15, can be configured to establish vehicle-to-everything (V2X) communication for the host vehicle V via wireless connectivity compliant with a predetermined standard.

Specifically, the communication module 15 is configured to retrieve, from probe servers in a cloud computing environment, latest HD map information, and cooperate with the locator ECU 144 to accordingly store the latest HD map information in the HD map database 143.

Additionally, the communication module 15 is configured to acquire traffic information related to traffic situations, such as traffic-jam information, from the probe servers and/or predetermined databases. Moreover, the communication module 15 is configured to acquire, from the probe servers and/or the predetermined databases, information including a lighting state of one or more traffic lights installed at respective intersections ahead of the host vehicle V, a timing of a change in the lighting state, and other information.

### Driver State Detection Unit

The driver state detection unit 16 is configured to detect a driver state. The “driver state” is a state of the driver D of the host vehicle V, and includes at least any one of a line-of-sight direction, a posture, a behavior, a psychological state, and the other similar information. Specifically, the driver state detection unit 16 of the predetermined embodiment detects, for example, the orientation of the face of the driver D, the line-of-sight direction of the driver D, the seating posture of the driver D, the gripping state of the steering wheel V5 of the driver D. The driver state detection unit 16 is configured to provide, via the n-vehicle communication network 10, the detected driver state to each of the predetermined components of the host vehicle V, such as the driving control device 17 and/or the HMI control unit 23.

### Driving Control Device

The driving control device 17 is configured to control driving of the host vehicle V, such as acceleration/deceleration and steering of the host vehicle V, based on the signals and/or sensor information acquired from, for example, the vehicle state sensor unit 11, the external state sensor unit 12, the surround monitoring sensor unit 13, and the locator 14. The driving control device 17 of the present embodiment is configured as an autonomous driving ECU or a driving assistance ECU. That is, the driving control device 17 is configured to execute predetermined driving control operations to implement an autonomous driving function and a driving assistance function. The predetermined driving control operations include all driving control operations, i.e., all dynamic driving tasks, corresponding to the SAE levels 1 to 4.

The driving control device 17 is configured as a vehicular microcomputer that includes a CPU, a ROM, a nonvolatile rewritable memory, a RAM, an I/O interface, and other peripheral devices. Specifically, the driving control device 17 includes, as functional components or functional units implemented on the vehicular microcomputer, an information acquisition unit 170, an automation level determiner 171, a perception controller 172, a driving controller 173, and a braking controller 174.

The information acquisition unit 170 acquires the signals and/or the information output from the vehicle state sensor unit 11, the external state sensor unit 12, the surround monitoring sensor unit 13, the locator 14, the communication module 15, and the driver state detection unit 16.

Additionally, the information acquisition unit 170 transmits signals and information to the HMI control unit 23, and receives (acquires) signals and information from the HMI control unit 23. That is, the driving control device 17 serves as the automation level determiner 171, the perception controller 172, the driving controller 173, and the braking controller 174 based on the signals and information acquired by the information acquisition unit 170.

In particular, the automation level determiner 171 of the present embodiment sets the driving automation level in the host vehicle V to any one of the SAE levels 0 to 4 based on the signals and information acquired by the information acquisition unit 170. In addition, the automation level determiner 171 switches activation and deactivation of the driving assistance function, such as ACC, while the driving automation level is set to the SAE level 2 or lower. That is, the automation level determiner 171 is configured to determine a driving mode; that is, the automation level determiner 171 determines whether to operate in a manual driving mode or an autonomous driving mode related to the autonomous driving in accordance with the driving automation level.

The automation level determiner 171 is configured to provide, via the in-vehicle communication network 10, information indicating the determined driving mode to each of the predetermined components of the host vehicle V, such as the HMI control unit 23.

The perception controller 172 is configured to control the surround monitoring sensor unit 13, so that the surround monitoring sensor unit 13 monitors and detects one or more objects around the host vehicle V under control of the perception controller 172. The perception controller 172 is additionally configured to recognize, based on the detected one or more objects around the host vehicle V, the one or more objects.

The driving controller 173 is configured to control operations of a drive system, i.e., a powertrain, installed in the host vehicle V. That is, the driving controller 173 is configured to control operations of one or more drive sources, such as an engine and/or a motor included in the powertrain, and control operations of a power transmission mechanism (e.g., a transmission mechanism, etc.), which is included in the powertrain and arranged between the one or more driving sources and the wheels of the host vehicle V.

The braking controller 174 is configured to control operations of a braking mechanism installed in the host vehicle V. That is, the braking controller 174 is configured to execute, for example, control of a braking pressure, which is a pressure of a working fluid in a friction brake mechanism included in the braking mechanism and control of a braking force to be applied to each wheel of the host vehicle V. Additionally, the braking controller 174 is configured to control the operating state, i.e., on/off and the braking force, of a regenerative braking system installed in the host vehicle V.

### Navigation System

The navigation system 18 is configured to calculate a scheduled travel route from the current position of the host vehicle V to a destination. Specifically, the navigation system 18 of the present embodiment is configured to calculate the scheduled travel route based on (i) the destination inputted by, for example the driver D, (ii) the HD map information acquired from the locator 14, and (iii) the position information on the host vehicle V, such as the current position and the current azimuth of the host vehicle V, acquired from the locator 14.

The navigation system 18 is additionally configured to provide, through the vehicular communication network 10, various information including the scheduled travel route as the calculation result to each of the predetermined components of the host vehicle V, such as the driving control device 17 and the HMI control unit 23. That is, the navigation system 18 is capable of instructing the HMI system 20 to execute (i) a sequential display of navigation images that show, for example, maps on which the current position of the host vehicle V and the scheduled travel route respectively appear and (ii) sequential audible output related to the navigation images.

### HMI System

The HMI system 20 is configured to accept input operations from one or more occupants, such as the driver D, other than accelerator operations and brake operations by the pedals V7, and visually and audibly output various types of information and/or contents toward the one or more occupants. Specifically, the output unit 21 includes an instrument panel 211, a console display 212, a HUD 213, an AV system 214, and a speaker 215. HUD is an abbreviation for Head-Up Display. Additionally, the input device 22 includes meter switches 221, console switches 222, steering wheel switches 223, a microphone 224, and a foot motion sensor 225.

The instrument panel 211 is mounted to the dashboard V4 and includes a meter display that displays the traveling state parameters of the host vehicle V, such as the speed and the coolant temperature of the host vehicle V, and an information display that displays various types of information, such as radio reception stations and the mileage of the host vehicle V.

The console display 212 is mounted to a center console (not shown) of the host vehicle V, and is configured to display the navigation images generated by the navigation system 18, contents for secondary tasks, and other types of information. The secondary tasks refers to non-driving tasks performed by the driver D, such as reading, operating a mobile communication terminal, viewing video contents. “Video contents” are, for example, movies, concert videos, music videos, television broadcasts, and the like. The secondary tasks are also referred to as “secondary activities”.

The HUD 213 is configured to display a virtual image including letters, figures, and/or characters in the driver's forward view. The HUD 213 is configured to project the virtual image in front of the driver D using AR technologies to accordingly superimpose the virtual image on the forward scenery including a road surface located on a traveling course of the host vehicle V; AR is abbreviated for Augmented Reality.

The AV system 214 is configured to cause the console display 212 and the speaker 215 to output music contents and/or video contents. The speaker 215 is configured to audibly output the contents supplied from the AV system 214, and audibly output various types of guidance, notification, or warning during driving of the host vehicle V.

Accordingly, the output device 21 serves as a vehicular device designed to provide visual and/or auditory feedback to the driver D.

The meter switches 221 are configured to accept occupant's various operations related to the information items and/or contents displayed on the instrument panel 211, such as an operation of resetting a trip meter included in the instrument panel 211.

The console switches 222 are disposed around the console display 212 and are configured to accept occupant's operations related to, for example, the navigation system 18 and the AV system 214.

The steering wheel switches 223 are mounted to the spokes or other portions of the steering wheel V5. The steering wheel switches 223 are configured to accept various operations, such as changing information items displayed on the instrument panel 211 and/or adjusting the volume of the AV system 214.

The microphone 224 is configured to receive audio input from the driver's speech.

The foot motion sensor 225 is a contactless sensor for detecting a driver's foot motion, which is a motion or movement of at least one of the feet D4 of the driver D, in a non-contact manner and is provided in an upper portion of the footwell space V6. The foot motion sensor 225 of the present embodiment is a so-called footwell camera that captures an image of the footwell space V6 from above, and is arranged to have a field of view that includes at least the pedals V7 and its surroundings. Specifically, the foot motion sensor 225 is configured to output an image signal including information related to the position and motion of at least one of the feet D4.

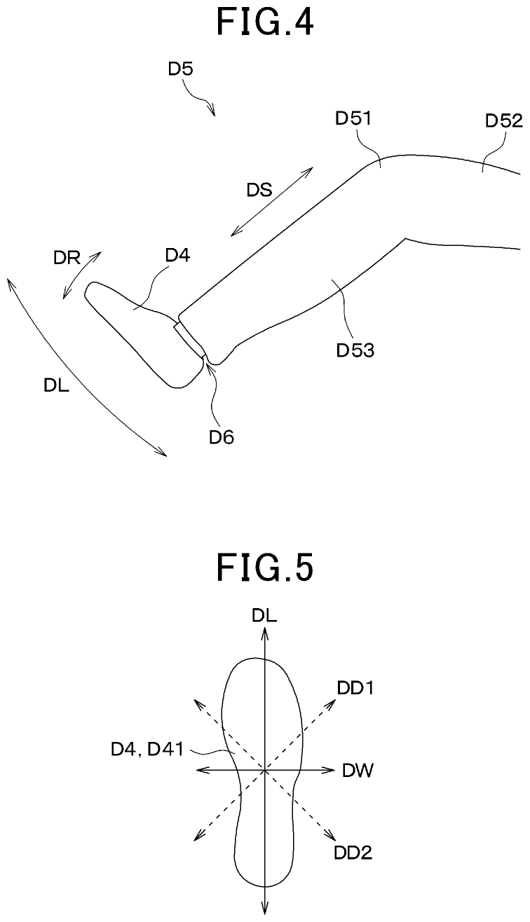

FIGS. 4 and 5 schematically show operating directions of one of the feet D4 (hereinafter also referred to as a “target foot D4”). As shown in FIG. 4, the target foot D4 can move in a depressing direction DS along a direction in which the shin D53 extends by expansion and contraction of the leg D5. Additionally, the target foot D4 can move in a dorsiflexion direction DR representing the direction of dorsiflexion and plantar flexion along a rotational path centered on the ankle D6. That is, the target foot D4 can rotate in the dorsiflexion direction in which the toes at the distal end of the target foot D4 approach the knee D51, and in the plantar flexion direction in which the toes move away from the knee D51.

Furthermore, the target foot D4 can move along a foot length direction DL as a first direction by rotation of the shin D53 along the longitudinal direction centered on the knee D51. The foot length direction DL is a direction that defines the length size of the target foot D4 along the direction from the heel toward the toes, and is orthogonal to a foot width direction DW, which will be described later.

The foot length direction DL is a direction along the longitudinal direction in a plan view from vertically above, and specifically intersects the longitudinal direction so as to be parallel or form a small angle of about 20 degrees or less with respect to the longitudinal direction.

The target foot D4 can move in the foot width direction DW as a second direction. The foot width direction DW is a width direction of the target foot D4, and intersects the lateral direction so as to be parallel or form a small angle of about 20 degrees or less with respect to the lateral direction in a plan view from vertically above. That is, the foot width direction DW is a direction along the lateral direction.

As shown in FIG. 5 in which the target foot D4 is viewed from above or obliquely from above with a line of sight along the depressing direction DS, the target foot D4 can move in a first inclined direction DD1 and a second inclined direction DD2 that intersect the foot length direction DL and the foot width direction DW. As shown in FIG. 5, let us assume that a coordinate system is defined wherein the horizontal and vertical axes correspond to the foot width direction DW and the foot length direction DL, respectively. In this assumption, the first inclined direction DD1 is a direction from the origin of the coordinate system toward the first quadrant or the third quadrant, and the second inclined direction DD2 is a direction from the origin toward the second quadrant or the fourth quadrant.

### HMI Control Unit

The HMI control unit (HCU) 23, which controls operations of the output unit 21 and the input unit 22 included in the HMI system 20, is configured as a vehicular microcomputer that includes a CPU, a ROM, a nonvolatile rewritable memory, a RAM, an I/O interface, and other peripheral devices (not shown). The HMI control unit 23 includes, as functional components or functional units implemented on the vehicular microcomputer, an input information acquisition unit 231 and a control operation determiner 232.

The input information acquisition unit 231 is configured to acquire, as input information, the signals output from the vehicle state sensor unit 11, the signals and information transmitted from the driving control device 17, and information transmitted from other components.

For example, the input information acquisition unit 231 is configured to acquire, as information to be displayed on the instrument panel 211 and other components included in the output device 21, (i) information related to the driving-state parameters including the speed of the host vehicle V, (ii) information related to the driving-environment parameters including the outside temperature and information on obstacles, and (iii) information related to the driving automation level and/or the driving mode of the host vehicle V.

Additionally, the input information acquisition unit 231 is configured to acquire input information from the input unit 22.

In particular, the input information acquisition unit 231 of the present embodiment includes a foot motion recognition unit 2311. The foot motion recognition unit 2311 is configured to recognize the position and motion of the target foot D4 based on the image signal acquired from the foot motion sensor 225; the image signal acquired by the foot motion sensor 225 includes information related to the position and motion of the target foot D4.

The control operation determiner 232 is configured to determine control operations for the host vehicle V in accordance with the acquired input information and the recognized position and motion of the target foot D4.

Specifically, the control operation determiner 232 is configured to determine operation details, i.e., control operations, for each of the driving control device 17, the navigation system 18, and the output unit 21. Then, the control operation determiner 232 is configured to output the determined control operations for each of the driving control device 17, the navigation system 18, and the output unit 21 to the corresponding one of the driving control device 17, the navigation system 18, and the output unit 21.

### Operation Overview

The following describes an overview representing how the vehicular system 1 configured set forth above operates according to the present embodiment, and advantageous benefits achieved by the vehicular system 1 with reference to the accompanying drawings.

The driving control device 17 of the vehicular system 1 controls driving of the host vehicle V based on the signals and/or information acquired from, for example, the vehicle state sensor unit 11, the external state sensor unit 12, the surround monitoring sensor unit 13, and the locator 14. Specifically, the driving control device 17 determines the amount of acceleration or deceleration and the amount of steering in accordance with (i) the acquired driving-state parameters of the host vehicle V, (ii) the acquired driving-environment parameters surrounding the host vehicle V, and (iii) operations input by the driver D. Then, the driving control device 17 executes motion control of the host vehicle V based on the determined amount of acceleration/deceleration and the amount of steering. Specifically, the drive system control unit 173 serves as the driving controller 173 to control operations of the one or more drive sources and operations of the power transmission mechanism, and serves as the braking controller 174 to control operations of the braking mechanism.

Additionally, the driving control device 17 selects one of the SAE levels based on, for example, the current position and speed of the host vehicle V and the driver state, and determines the selected one of the SAE levels as the driving automation level, thereby operating the host vehicle V in the determined driving automation level. For example, if the vehicular system 1 is activated without a driver's input and an initial setting, the driving control device 17 sets the driving automation level to the SAE level 1, in which the driving control device 17 is capable of executing emergency automated braking and collision mitigation control. The “initial setting” here includes the setting of the driving automation level and/or the driving mode saved at the last deactivation of the vehicular system 1, which can be used for the next activation of the vehicular system 1.

Accordingly, when the initial setting for example indicates that the autonomous driving was being executed immediately before the last deactivation of the vehicular system 1, the driving control device 17 is capable of setting the driving automation level to one of the SAE levels 3 to 5 corresponding to the autonomous driving mode at the current activation of the vehicular system 1. As another example, when (i) the host vehicle V, which has not satisfied the ODD conditions for an autonomous driving level, satisfies all the ODD conditions for the autonomous driving level and (ii) transition approval to the autonomous driving level is inputted from the driver D, the driving control device 17 transitions the driving automation level from the current SAE level (which is 2 or lower) to the autonomous driving level.

The patent publication, i.e., Japanese Patent Application Publication No. 2014-193665 set forth above, discloses the technology that, when determining that the driver's selected foot D4 has approached any of the pedals V7 of the host vehicle V, executes preparatory operations prior to control operations triggered by depression of the pedal. However, the technology disclosed in the patent publication determines whether the driver's selected foot D4 has approached any of the pedals V7, based on whether short-range communication has been established between the IC tag mounted to the shoe of the driver D and the radio wave receiver mounted to each of the pedals V7. Therefore, although such a technology can determine whether a predetermined approach state between the pedals V7 and the driver's selected foot D4 is established, such a technology may not detect or recognize an actual motion of the driver's selected foot D4.

In contrast, the foot motion recognition unit 2311 of the present embodiment uses the foot motion sensor 225 to detect and recognize, in a non-contact manner, a driver's foot operation, which is a motion of the target foot D4 of the driver D of the host vehicle V. Additionally, the information acquisition unit 170 included in the driving control device 17 acquires the recognized driver's foot operation from the foot motion recognition unit 2311 as a recognition result.

Then, the braking controller 174 included in the driving control device 17 controls the braking operation of the host vehicle V based on the acquired driver's foot operation so as to improve energy efficiency of the host vehicle V.

That is, the vehicular system 1 is configured to detect and recognize, during driving of the host vehicle V, a motion of the target foot D7, typically the right foot D41, of the driver D indicative of an intent to operate any pedal V7 (pre-operation motion), and reflect the recognized motion of the target foot D7 (right foot D41) on control of the host vehicle V. This configuration therefore makes it possible to improve responsiveness in anticipating driver's intention, which contributes to enhancing energy efficiency, i.e., fuel efficiency or electricity efficiency, of the host vehicle V.

Energy efficiency for vehicles is higher when energy once used for generating driving force is fully used as traveling energy through coasting, rather than being recovered using regenerative braking. Coasting for a vehicle is inertial traveling by cutting off transmission of driving force to wheels of the vehicle. It is therefore preferable for vehicles to use coasting as preferentially as possible over regenerative braking from the viewpoint of improving energy efficiency.

From this viewpoint, detecting an actual movement of the target foot D4 of the driver D toward any pedal V7, for example, detecting a motion of the target foot D4 between the accelerator pedal V71 and the brake pedal V72 (e.g., a movement toward a pedal operation) enables estimation of an accelerator intention or a brake intention of the driver D.

For example, tracking and estimating that the target foot D4 is heading toward the brake pedal V72 immediately after release of the accelerator pedal V71 enables the brake intention of the driver D to be estimated.

Accordingly, the driving control device 17 of the present embodiment i configured to change an inter-vehicle distance, which is a distance between the host vehicle V and a preceding vehicle, in inter-vehicle distance control in accordance with the position and/or motion of the target foot D4 of the driver D. In particular, the braking controller 174 of the driving control device 17 is configured to control the operating state of the regenerative braking of the host vehicle V based on the motion of the target foot D4 detected using the foot motion sensor 225.

The following describes specific examples, each illustrating how the driving control device 17 executes control processes to improve the energy efficiency of the host vehicle V in accordance with the position and/or motion of the target foot D4 of the driver D. The present disclosure, however, is naturally not limited to the above specific examples.

### Specific Example 1

When the target foot D4 of the driver D is moving toward the brake pedal V72, the driver's intention of braking the host vehicle V can be estimated.

From this viewpoint, the braking controller 174 increases, in response to detecting movement of the target foot D4 of the driver D toward the brake pedal V72, the level of the regenerative braking to be higher than that immediately before the detection. Specifically, let us assume that a state in which the target foot D4, i.e., the right foot D41, of the driver D is on the brake pedal V72 is defined as a brake-on state, a state in which the right foot D41 is away from (or separated from) the brake pedal V72 is defined as a separated state, and a state in which the right foot D41 is moving toward the brake pedal V72 is defined as a brake transition state.

In this assumption, the braking controller 174 increases the level of the regenerative braking in the brake transition state to be higher than that in the separated state, and increases the level of the regenerative braking in the brake-on state to be higher than that in the brake transition state.

Additionally, when the moving speed toward the brake pedal V72 is high, the driver's intention of braking the host vehicle V can be estimated.

From this viewpoint, the braking controller 174 increases the level of the regenerative braking in the brake transition state as the moving speed toward the brake pedal V72 increases.

That is, the vehicular system 1 is configured to preliminarily set the level of the regenerative braking to a relatively low level, i.e., a relatively mild level, and to increase the level of the regenerative braking in response to a driver's request and/or situational necessity of braking. This configuration enables the driver's intention to be reflected in the driving control of the host vehicle V more promptly and accurately. In particular, the present disclosure is configured to set the level of the regenerative braking to a relatively low level at the start of the regenerative braking and gradually increase the level of the regenerative braking in response to a driver's request and/or situational necessity of braking. This configuration therefore makes it possible to improve the occupant's ride comfort of the host vehicle V.

### Specific Example 2

In the separated state in which the driver's braking intention is estimated to be low or no braking intension is estimated, it is preferable to use coasting as much as possible from the viewpoint of improving energy efficiency of the host vehicle V as described above. Accordingly, the braking controller 174 of the present specific example 2 is configured to, in the separated state, stop the regenerative braking to thereby cause the host vehicle V to travel in a coasting mode. This therefore makes it possible to further improve energy efficiency of the host vehicle V while ensuring execution of the regenerative braking in response to a driver's request and/or situational necessity of braking.

Depending on, for example, traveling conditions of the host vehicle V, it may be preferable to switch the traveling mode of the host vehicle V from the coasting mode to a regenerative-braking mode while in the separated state, so that the regenerative braking can be applied in accordance with the surrounding environment around the host vehicle V.

Specifically, let us assume that the separated state of the target foot D4 includes (i) a state in which the target foot D4, i.e., the right foot D41, of the driver D is on the accelerator pedal V71 is defined as an accelerator-on state, (ii) a state in which the right foot D41 is moving toward the accelerator pedal V71 is defined as an accelerator transition state, and (iii) a state other than the accelerator-on state and the accelerator transition state is defined as an intermediate state.

In the intermediate state, the right foot D41 of the driver D is typically on or above the floor mat V10, with the left foot D42 being positioned on the footrest V8.

In this assumption, the braking controller 174 can be configured to differentiate, in the separated state, the traveling mode of the host vehicle V between the intermediate state and either the accelerator-on state or the accelerator transition state, and set, in the separated state, the traveling mode of the host vehicle V to the coasting mode at least in either the accelerator-on state or the accelerator transition state.

That is, while the right foot D41 is in the separated state, the braking controller 174 can be configured to:

(I) set the traveling mode of the host vehicle V to the regenerative-braking mode with a relatively low level of regenerative braking when the right foot D41 is in the intermediate state; and

(II) set the traveling mode of the host vehicle V to the coasting mode when the right foot D41 is in either the accelerator-on state or the accelerator transition state.

This configuration enables the energy efficiency of the host vehicle V to be further improved while ensuring execution of regenerative braking in response to a driver's request and/or situational necessity of braking.

### Specific Example 3

The braking controller 174 of the present specific example 2 is configured to control the operating state of the regenerative braking of the host vehicle V based on (i) the motion of the target foot D4 detected using the foot motion sensor 225 and (ii) the traveling situation of the host vehicle V. That is, the braking controller 174 is configured to adjust the level of the regenerative braking of the host vehicle V in accordance with (i) a driver's request and/or situational necessity of braking estimated by the recognized motion of the target foot D4 and (ii) the traveling situation of the host vehicle V. This makes it possible to further improve the energy efficiency of the host vehicle V.

Specifically, the specific example 3 includes multiple sub-examples (e.g., specific Examples 3-1, 3-2, 3-3, and 3-4) as described below.

### Specific Example 3-1

The braking controller 174 of the present specific example 3-1 is configured to control the operating state of the regenerative braking of the host vehicle V in accordance with the type, curve curvature, and/or gradient of a road on which the host vehicle V is traveling. This makes it possible to further improve the energy efficiency of the host vehicle V while ensuring execution of regenerative braking in response to a driver's request and/or situational necessity of braking.

Specifically, on automobile-exclusive roads such as expressways, braking requests from the driver D and situational braking necessities occur less frequently than on general roads. Consequently, the host vehicle V can be set to the coasting mode more often or for longer durations.

In contrast, on general roads, braking requests from the driver D and situational braking necessities may occur more frequently than on automobile-exclusive roads. This depends on, for example, the signal state of one or more traffic lights ahead of the host vehicle V and/or the presence of a preceding vehicle.

From this viewpoint, the braking controller 174 is configured to change operating parameters of the regenerative braking of the host vehicle V, which include, for example, (i) the operating timing, (ii) the level, and (iii) the operational range of the regenerative braking, between an automobile-exclusive road and a general road. That is, when the host vehicle V is traveling on a general road, the braking controller 174 is configured to increase the operational range and the level of the regenerative braking to be greater than when traveling on an automobile-exclusive road.

Additionally, when the host vehicle V is traveling on a general road, the braking controller 174 is configured to change the operational range and level of the regenerative braking in accordance with the width of the general road. In more detail, the braking controller 174 is configured to increase the operational range and level of the regenerative braking as the width of the general decreases or as the number of lanes in the general road decreases. Furthermore, the braking controller 174 is configured to increase the operational range and level of the regenerative braking as a speed limit of the general road decreases.

Moreover, on roads with a large curvature, i.e., with a small radius of curvature, a deceleration effect during coasting of a vehicle increases due to road surface resistance. From this viewpoint, the braking controller 174 is configured to prioritize the coasting mode over the regenerative-braking mode as the curvature of a curve road on which the host vehicle V is traveling increases; specifically, the controller 174 maximizes the use of the coasting mode when the curvature of the curve road is large, as compared to when the curvature of the curve road is small.

Similarly, on uphill slopes, gravitational resistance increases the deceleration effect during coasting. Accordingly, the braking controller 174 is configured to maximize the use of the coasting mode when the host vehicle V is traveling on an uphill slope. In contrast, on downhill slopes, the braking controller 174 sets the level of the regenerative braking higher than on uphill slopes to counteract gravitational acceleration.

### Specific Example 3-2

Depending on the remaining amount of fuel or electric energy in the host vehicle V (i.e., the remaining capacity of a battery of the host vehicle V), and/or a planned travel distance to a destination, it may be better to actively use the regenerative braking of the host vehicle V.

From this viewpoint, the braking controller 174 of the present specific example 3-2 is configured to control the operating state of the regenerative braking of the host vehicle V in accordance with the remaining amount of fuel or electric energy in the host vehicle V and/or the planned travel distance to the destination. Specifically, the braking controller 174 is configured to, for example, increase the frequency of use of the regenerative braking of the host vehicle V to replenish the battery, thereby preserving the cruising range of the host vehicle V as the remaining amount of fuel or electric energy in the host vehicle V decreases and/or the planned travel distance increases.

### Specific Example 3-3

When the number of occupants or a cargo load amount in the host vehicle V is large, propulsion due to inertia increases and a cruising range during coasting becomes longer, whereas a braking distance at the same degree of the regenerative braking of the host vehicle V becomes longer.

From this viewpoint, the braking controller 174 is configured to control the operating state the regenerative braking of the host vehicle V in accordance with the load amount of the host vehicle V, which includes the number of occupants in the host vehicle V. Specifically, the braking controller 174 is configured to increase the level of the regenerative braking of the host vehicle V as the load amount of the host vehicle V increases. This makes it possible to satisfy both appropriate effectiveness (i.e., performance) of the regenerative braking and improvement of energy efficiency of the host vehicle V.

### Specific Example 3-4

For example, because the traffic light at the immediate intersection ahead of the host vehicle V is red, the driver D may move the right foot D41 onto the brake pedal V72 to take a braking preparation posture. However, because the traffic light is actually scheduled to change to green shortly, there may be a case where the host vehicle V can safely pass in the coasting mode through the immediate intersection without using the braking depending on a positional relationship of the host vehicle V with respect to each of the immediate intersection, a preceding vehicle, and other objects.

From this viewpoint, the braking controller 174 is configured to control the operating state of the regenerative braking in accordance with road traffic conditions ahead of the host vehicle V. Specifically, the braking controller 174 is configured to control the operating state of the regenerative braking of the host vehicle V in accordance with the lighting state and/or change timing of each traffic light ahead of the host vehicle V acquired using the V2X communication between the host vehicle V and the corresponding traffic light.

Additionally, the braking controller 174 is configured to control the operating state of the regenerative braking of the host vehicle V based on the presence and status of one or more preceding vehicles ahead of the host vehicle V, as acquired via V2X communication or the surrounding monitor sensor unit 13.

The above configuration makes it possible to further improve the energy efficiency of the host vehicle V while ensuring execution of regenerative braking in response to a driver's request and/or situational necessity of braking.

### Specific Example 4

Frequent execution of acceleration and deceleration of the host vehicle V during the execution of ACC, occurring in motion of a preceding vehicle, may decrease energy efficiency of the host vehicle V. Accordingly, maintaining a wider inter-vehicle distance may enable more energy-efficient driving.

On the other hand, depending on the driving style of the driver D, the driver D may wish to avoid the psychological stress caused by other vehicles cutting in when the inter-vehicle distance is excessively wide. Accordingly, the driver D may prefer a relatively narrow inter-vehicle distance.

From this viewpoint, the driving control device 17 is configured to change the inter-vehicle distance during the execution of ACC in accordance with the position and/or motion of the right foot D41 of the driver D. Specifically, the driving control device 17 may be configured to, for example, set the inter-vehicle distance to be narrow when the right foot D41 of the driver D is on the accelerator pedal V71 or moves toward the accelerator pedal V71.

In contrast, the driving control device 17 may be configured to set the inter-vehicle distance to be wide with emphasis on energy efficiency improvement when the right foot D41 of the driver D is on the brake pedal V72 or moves toward the brake pedal V72.

Specifically, the driving controller 17 is configured to set the inter-vehicle distance to be narrower when the right foot D41 is positioned on the accelerator pedal V71 than when it is not, or when the right foot D41 is moving toward the accelerator pedal V71 than when it is not moving toward the accelerator pedal V71.

Conversely, the driving controller 17 may be configured to set the inter-vehicle distance to be wider to prioritize energy efficiency when the right foot D41 is positioned on the brake pedal V72 than when it is not, or when the right foot D41 is moving toward the brake pedal V72 than when it is not moving toward the brake pedal V72.

The above adaptive control enhances the convenience and responsiveness of the ACC according to the driver's intention.

While the present embodiment of the present disclosure has been described above, the present disclosure is not limited to the present embodiment. Specifically, the present disclosure includes various modifications and/or alternatives of the present embodiment within the scope of the present disclosure.

The following describes typical modifications of the present embodiment. In the typical modifications, to the same parts or equivalent parts of the present embodiment, like reference characters are assigned, so that, as the descriptions of each of the same or equivalent parts of the typical modifications, the descriptions of the corresponding one of the same or equivalent parts of the present embodiment can be employed unless technical contradiction or otherwise specified.

The present disclosure is not limited at all to the specific device configuration shown in the above embodiment. For example, the vehicle V in which the vehicular system 1 is installed is not limited to a passenger vehicle. Specifically, such a vehicle V may be a large vehicle such as a freight truck. There is no particular limitation on the number of wheels, and it may be a three-wheeled vehicle, or a six-wheeled or eight-wheeled vehicle such as a freight truck. The type of the vehicle V may be a conventional vehicle equipped only with an internal combustion engine, an electric vehicle or a fuel cell vehicle not equipped with an internal combustion engine, or a so-called hybrid vehicle. The shape and structure of the vehicle body V1 are also not limited to a box shape, i.e., a substantially rectangular shape in a plan view. There are also no particular limitations on the use of the vehicle V, the positions of the driver's seat V3 and the steering wheel V5 in the vehicle width direction, the number of occupants, and the like. That is, for example, the host vehicle V may have a configuration as a so-called “left-hand drive vehicle” adapted to a road traffic legal system of right-hand traffic in the United States or the like. Alternatively, for example, the host vehicle V may have a configuration in which seats for occupants are provided on both the left and right sides of the driver's seat V3.

As a communication standard for configuring the in-vehicle system 1, one other than CAN®, such as FlexRay®, may also be adopted. Further, the communication standard for configuring the vehicular system 1 is not limited to one type. For example, the vehicular system 1 may have a sub-network line compliant with a communication standard such as LIN. LIN is an abbreviation for Local Interconnect Network.

The vehicle state sensor unit 11, the external state sensor unit 12, and the surround monitoring sensor unit 13 are also not limited to the above embodiment and examples. For example, the surround monitoring sensor unit 13 may include one or more sonars, i.e., ultrasonic sensors. Alternatively, the surround monitoring sensor unit 13 may include two or more types of sensors among a millimeter-wave radar sensor, a submillimeter-wave radar sensor, a laser radar sensor, and an ultrasonic sensor. There are also no particular limitations on the number of various types of sensors installed to the host vehicle V.

The locator 14 is not limited to the above embodiment and examples. For example, the locator 14 may be not comprised of a three-axis accelerometer and a three-axis gyro sensor in the housing thereof. Specifically, the inertial sensor 142 of the locator 14 may be configured to receive output signals from a three-axis accelerometer and a three-axis gyro sensor, such as an angular velocity sensor, provided outside the housing of the locator 14, which are included in the vehicle state sensor unit 11.

In the above embodiment, the driving control device 17 is configured to be capable of executing vehicle control operations corresponding to the SAE levels 0 to 4. However, the present disclosure is not limited to such a configuration.

Specifically, the driving control device 17 of the present disclosure may be configured to execute vehicle control operations corresponding to the SAE levels 1 to 5. Additionally, the driving automation levels or their categories may be not limited to those defined in “SAE J3016”.

Specifically, in “SAE J3016”, it is defined that the higher the driving automation level is, the larger the numerical value corresponding to the driving automation level becomes. However, the present disclosure is not limited to such a definition. That is, the present disclosure can be similarly applied to a standard in which the highest driving automation level is “Level 1” and the numerical value corresponding to the driving automation level increases as the driving automation level decreases.

The output unit 21 is not limited to the above configuration including the instrument panel 211, the console display device 212, and the HUD device 213. Specifically, the instrument panel 211 and the console display device 212 may be integrated with one another. The HUD device 213 may be omitted.

The input unit 22 is also not limited to the above configuration. Specifically, the input unit 22 may for example include a touch panel mounted on the display surface of the instrument panel 211 or the console display 212 instead of or together with the meter switches 221 and the console switches 222.

The above embodiment uses a footwell camera as the foot motion sensor 225. Such a footwell camera may be a visible light camera, an infrared camera, or a combination of both of the cameras. The present disclosure is, however, not limited to the above configuration. Specifically, instead of or together with the footwell camera, an ultrasonic sensor or one or more other sensors may be used as the foot motion sensor 225. Additionally, the installation position of the foot motion sensor 225 is not limited to the upper portion of the footwell space V6. Specifically, the foot motion sensor 225 may be provided in the footwell space V6 so as to be located on a lateral side, in front, or diagonally in front of the pedal group V7. Furthermore, the foot motion sensor 225 may be comprised of a plurality of foot motion sensors 225 mounted at respective multiple locations in the footwell space V6.

The present disclosure is not limited to the specific operation examples described in the above embodiment and examples. For example, as illustrated in FIG. 5, the foot length direction DL may be the longitudinal direction, and the foot width direction DW may be the lateral direction. Additionally, the brake pedal V72 may also be operated by the left foot D42 of the driver D. That is, the present disclosure can also be suitably applied to so-called “left-foot braking”.

Similar expressions, such as “obtaining”, “calculation”, “estimation”, “detection”, and “determination”, can be mutually substituted for one another unless the substitution produces technological inconsistency.

One or more components in the present embodiment are not necessarily essential components except for (i) one or more components that are described as one or more essential components or (ii) one or more components that are essential in principle.

Specific values disclosed in the present embodiment, each of which represents the number of components, a physical quantity, and/or a range of a physical parameter, are not limited thereto except that (i) the specific values are obviously essential or (ii) the specific values are essential in principle.

The specific structure and direction of each component described in the present embodiment are not limited thereto except for cases in which (1) the specific structure and direction are described to be essential or (2) the specific structure and direction are required in principle. Additionally, the specific structural or functional relationship between components described in the present embodiment is not limited thereto except for cases in which (1) the specific structural or functional relationship is described to be essential or (2) the specific structural or functional relationship is required in principle.

Modifications of the present disclosure are not limited to those described set forth above. For example, specific examples described set forth above can be combined with each other unless the combination produces technological inconsistency, and similarly the modifications set forth above can be combined with each other unless the combination produces technological inconsistency. At least part of the present embodiment can be combined with at least part of the modifications set forth above unless the combination produces technological inconsistency.

The present disclosure includes the following technological aspects.

### Technological Aspect 1-1

A vehicular system (1) to be installed in a vehicle (V) according to a technological aspect 1-1 includes a contactless foot motion sensor (225) mounted to the vehicle and configured to output a signal including information indicative of a motion of a target foot (D4) of a driver (D) of the vehicle. The vehicular system includes a driving control device (17) configured to acquire, from the contactless foot motion sensor, the signal including the information indicative of the motion of the target foot of the driver, and recognize, based on the information, the motion of the target foot of the driver. Then, the driving control device is configured to control a braking operation of the vehicle based on the recognized motion of the target foot of the driver so as to improve energy efficiency of the vehicle.

### Technological Aspect 1-2

In the vehicular system according to a technological aspect 1-2, which depends from the technological aspect 1-1, the driving control device is configured to control an operating state of a regenerative braking of the vehicle based on the recognized motion of the target foot of the driver.

### Technological Aspect 1-3

In the vehicular system according to a technological aspect 1-3, which depends from the technological aspect 1-2, the driving control device is configured to increase, in response to detecting movement of the target foot of the driver toward a brake pedal (V72) of the vehicle, a level of the regenerative braking to be higher than that immediately before a detection of the movement of the target foot.

### Technological Aspect 1-4

In the vehicular system according to a technological aspect 1-4, which depends from the technological aspect 1-3, a first state in which the target foot of the driver is on the brake pedal is defined as a brake-on state, a second state in which the target foot is away from the brake pedal is defined as a separated state, and a third state in which the target foot is moving toward the brake pedal is defined as a brake transition state. The driving control device is configured to increase the level of the regenerative braking in the brake transition state to be higher than that in the separated state, and increase the level of the regenerative braking in the brake-on state to be higher than that in the brake transition state.

### Technological Aspect 1-5

In the vehicular system according to a technological aspect 1-5, which depends from the technological aspect 1-4, the driving control device is configured to stop, in the separated state, the regenerative braking to cause the vehicle to travel in a coasting mode.

### Technological Aspect 1-6

In the vehicular system according to a technological aspect 1-6, which depends from the technological aspect 1-5, the separated state includes a first sub-state in which the target foot of the driver is on an accelerator pedal (V71) of the vehicle, a second sub-state in which the target foot is moving toward the accelerator pedal is defined as an accelerator transition state, and a third sub-state other than the accelerator-on state and the accelerator transition state is defined as an intermediate state. The driving control device is configured to differentiate a traveling mode of the vehicle between the intermediate state and either the accelerator-on state or the accelerator transition state, and set the traveling mode of the vehicle to the coasting mode at least in either the accelerator-on state or the accelerator transition state.

### Technological Aspect 1-7

In the vehicular system according to a technological aspect 1-7, which depends from any one of the technological aspects 1-3 to 1-5, the driving control device is configured to increase the level of the regenerative braking of the vehicle as a moving speed of the target foot toward the brake pedal increases.

### Technological Aspect 1-8

In the vehicular system according to a technological aspect 1-8, which depends from any one of the technological aspects 1-2 to 1-7, the driving control device is configured to control the operating state of the regenerative braking of the vehicle based on the recognized motion of the target foot of the driver and a traveling situation of the vehicle.

### Technological Aspect 1-9

In the vehicular system according to a technological aspect 1-9, which depends from the technological aspect 1-8, the driving control device is configured to control the operating state of the regenerative braking of the vehicle based on at least one of a type, a curve curvature, and a gradient of a road on which the vehicle is traveling.

### Technological Aspect 1-10

In the vehicular system according to a technological aspect 1-10, which depends from the technological aspect 1-8 or 1-9, the driving control device is configured to control the operating state of the regenerative braking of the vehicle based on a remaining amount of fuel or electric energy in the vehicle.

### Technological Aspect 1-11

In the vehicular system according to a technological aspect 1-11, which depends from any one of the technological aspects 1-8 to 1-10, the driving control device is configured to control the operating state of the regenerative braking of the vehicle based on a load amount of the vehicle including the number of one or more occupants in the vehicle.

### Technological Aspect 1-12

In the vehicular system according to a technological aspect 1-12, which depends from any one of the technological aspects 1-8 to 1-11, the driving control device is configured to control the operating state of the regenerative braking of the vehicle based on a planned travel distance of the vehicle.

### Technological Aspect 1-13

In the vehicular system according to a technological aspect 1-13, which depends from any one of the technological aspects 1-8 to 1-12, the driving control device is configured to control the operating state of the regenerative braking of the vehicle based on one or more road traffic conditions ahead of the vehicle.

### Technological Aspect 1-14

In the vehicular system according to a technological aspect 1-14, which depends from the technological aspect 1-13, the driving control device is configured to control the operating state of the regenerative braking of the vehicle based on, as the one or more road traffic conditions, at least one of (i) a lighting state of one or more traffic lights located ahead of the vehicle and (ii) a change timing of each of the traffic lights located ahead of the vehicle.

### Technological Aspect 1-15

In the vehicular system according to a technological aspect 1-15, which depends from any one of the technological aspects 1-1 to 1-14, the driving control device is configured to change an inter-vehicle distance between the vehicle and a preceding vehicle in inter-vehicle distance control in accordance with at least one of a position and the motion of the target foot of the driver.

### Technological Aspect 1-16

In the vehicular system according to a technological aspect 1-16, which depends from any one of the technological aspects 1-1 to 1-15, the target foot of the driver is a right foot thereof.

### Technological Aspect 2-1

A driving control device (17) for controlling driving of a vehicle (V) according to a technological aspect 2-1 includes a controller (17, 171, 174) configured to acquire, from a contactless sensor (225) mounted to the vehicle, a signal including information indicative of a motion of a target foot (D4) of a driver (D) of the vehicle, and recognize, based on the information, the motion of the target foot of the driver. The controller is configured to control a braking operation of the vehicle based on the recognized motion of the target foot of the driver so as to improve energy efficiency of the vehicle.

### Technological Aspect 2-2

In the driving control device according to a technological aspect 2-2, which depends from the technological aspect 2-1, the controller is configured to control an operating state of a regenerative braking of the vehicle based on the recognized motion of the target foot of the driver.

### Technological Aspect 2-3

In the driving control device according to a technological aspect 2-3, which depends from the technological aspect 2-2, the controller is configured to increase, in response to detecting movement of the target foot of the driver toward a brake pedal (V72) of the vehicle, a level of the regenerative braking to be higher than that immediately before a detection of the movement of the target foot.

### Technological Aspect 2-4

In the driving control device according to a technological aspect 2-4, which depends from the technological aspect 2-3, a first state in which the target foot of the driver is on the brake pedal is defined as a brake-on state, a second state in which the target foot is away from the brake pedal is defined as a separated state, and a third state in which the target foot is moving toward the brake pedal is defined as a brake transition state. The controller is configured to increase the level of the regenerative braking in the brake transition state to be higher than that in the separated state, and increase the level of the regenerative braking in the brake-on state to be higher than that in the brake transition state.

### Technological Aspect 2-5

In the driving control device according to a technological aspect 2-5, which depends from the technological aspect 2-4, the controller is configured to stop, in the separated state, the regenerative braking to cause the vehicle to travel in a coasting mode.

### Technological Aspect 2-6

In the driving control device according to a technological aspect 2-6, which depends from the technological aspect 2-5, the separated state includes a first sub-state in which the target foot of the driver is on an accelerator pedal (V71) of the vehicle, a second sub-state in which the target foot is moving toward the accelerator pedal is defined as an accelerator transition state, and a third sub-state other than the accelerator-on state and the accelerator transition state is defined as an intermediate state. The controller is configured to differentiate a traveling mode of the vehicle between the intermediate state and either the accelerator-on state or the accelerator transition state, and set the traveling mode of the vehicle to the coasting mode at least in either the accelerator-on state or the accelerator transition state.

### Technological Aspect 2-7

In the driving control device according to a technological aspect 2-7, which depends from any one of the technological aspects 2-3 to 2-6, the controller is configured to increase the level of the regenerative braking of the vehicle as a moving speed of the target foot toward the brake pedal increases.

### Technological Aspect 2-8

In the driving control device according to a technological aspect 2-8, which depends from any one of the technological aspects 2-2 to 2-7, the controller is configured to control the operating state of the regenerative braking of the vehicle based on the recognized motion of the target foot of the driver and a traveling situation of the vehicle.

### Technological Aspect 2-9

In the driving control device according to a technological aspect 2-9, which depends from the technological aspect 2-8, the controller is configured to control the operating state of the regenerative braking of the vehicle based on at least one of a type, a curve curvature, and a gradient of a road on which the vehicle is traveling.

### Technological Aspect 2-10

In the driving control device according to a technological aspect 2-10, which depends from the technological aspect 2-8 or 2-9, the controller is configured to control the operating state of the regenerative braking of the vehicle based on a remaining amount of fuel or electric energy in the vehicle.

### Technological Aspect 2-11

In the driving control device according to a technological aspect 2-11, which depends from any one of the technological aspects 2-8 to 2-10, the controller is configured to control the operating state of the regenerative braking of the vehicle based on a load amount of the vehicle including the number of one or more occupants in the vehicle.

### Technological Aspect 2-12

In the driving control device according to a technological aspect 2-12, which depends from any one of the technological aspects 2-8 to 2-11, the controller is configured to control the operating state of the regenerative braking of the vehicle based on a planned travel distance of the vehicle.

### Technological Aspect 2-13

In the driving control device according to a technological aspect 2-13, which depends from any one of the technological aspects 2-8 to 2-12, the controller is configured to control the operating state of the regenerative braking of the vehicle based on one or more road traffic conditions ahead of the vehicle.

### Technological Aspect 2-14

In the driving control device according to a technological aspect 2-14, which depends from the technological aspect 2-13, the controller is configured to control the operating state of the regenerative braking of the vehicle based on, as the one or more road traffic conditions, at least one of (i) a lighting state of one or more traffic lights located ahead of the vehicle and (ii) a change timing of each of the traffic lights located ahead of the vehicle.

### Technological Aspect 2-15

In the driving control device according to a technological aspect 2-15, which depends from any one of the technological aspects 2-1 to 2-14, the controller is configured to change an inter-vehicle distance between the vehicle and a preceding vehicle in inter-vehicle distance control in accordance with at least one of a position and the motion of the target foot of the driver.

### Technological Aspect 2-16

In the driving control device according to a technological aspect 2-16, which depends from any one of the technological aspects 2-1 to 2-15, the target foot of the driver is a right foot (D41) thereof.

### Technological Aspect 3

A vehicular system (1) to be installed in a vehicle (V) according to a technological aspect 3 includes a contactless foot motion sensor (225) mounted to the vehicle and configured to output a signal including information indicative of a motion of a target foot (D4) of a driver (D) of the vehicle. The vehicular system includes the driving control device according to the technological aspect 2-1. The contactless sensor of the technological aspect 2-1 is the contactless foot motion sensor.

1. A driving control device for controlling driving of a vehicle, the driving control device comprising:
a controller configured to:
acquire, using a contactless sensor mounted to the vehicle, sensor information indicative of a motion of a target foot of a driver of the vehicle;
recognize, based on the sensor information, the motion of the target foot of the driver; and
control a braking operation of the vehicle based on the recognized motion of the target foot of the driver so as to improve energy efficiency of the vehicle.

2. The driving control device according to claim 1, wherein:
the controller is configured to control an operating state of a regenerative braking of the vehicle based on the recognized motion of the target foot of the driver.

3. The driving control device according to claim 2, wherein:
the controller is configured to increase, in response to detecting movement of the target foot of the driver toward a brake pedal of the vehicle, a level of the regenerative braking to be higher than that immediately before a detection of the movement of the target foot.

4. The driving control device according to claim 3, wherein:
a first state in which the target foot of the driver is on the brake pedal is defined as a brake-on state;
a second state in which the target foot is away from the brake pedal is defined as a separated state;
a third state in which the target foot is moving toward the brake pedal is defined as a brake transition state; and
the controller is configured to:
increase the level of the regenerative braking in the brake transition state to be higher than that in the separated state; and
increase the level of the regenerative braking in the brake-on state to be higher than that in the brake transition state.

5. The driving control device according to claim 4, wherein:
the controller is configured to, in the separated state, stop the regenerative braking to thereby cause the vehicle to travel in a coasting mode.

6. The driving control device according to claim 5, wherein:
the separated state includes:
a first sub-state in which the target foot of the driver is on an accelerator pedal of the vehicle;
a second sub-state in which the target foot is moving toward the accelerator pedal is defined as an accelerator transition state; and
a third sub-state other than the accelerator-on state and the accelerator transition state is defined as an intermediate state; and
the controller is configured to:
differentiate a traveling mode of the vehicle between the intermediate state and either the accelerator-on state or the accelerator transition state; and
set the traveling mode of the vehicle to the coasting mode at least in either the accelerator-on state or the accelerator transition state.

7. The driving control device according to claim 3, wherein:
the controller is configured to increase the level of the regenerative braking of the vehicle as a moving speed of the target foot toward the brake pedal increases.

8. The driving control device according to claim 2, wherein:
the controller is configured to control the operating state of the regenerative braking of the vehicle based on the recognized motion of the target foot of the driver and a traveling situation of the vehicle.

9. The driving control device according to claim 8, wherein:
the controller is configured to control the operating state of the regenerative braking of the vehicle based on at least one of a type, a curve curvature, and a gradient of a road on which the vehicle is traveling.

10. The driving control device according to claim 8, wherein:
the controller is configured to control the operating state of the regenerative braking of the vehicle based on a remaining amount of fuel or electric energy in the vehicle.

11. The driving control device according to claim 8, wherein:
the controller is configured to control the operating state of the regenerative braking of the vehicle based on a load amount of the vehicle including the number of one or more occupants in the vehicle.

12. The driving control device according to claim 8, wherein:
the controller is configured to control the operating state of the regenerative braking of the vehicle based on a planned travel distance of the vehicle.

13. The driving control device according to claim 8, wherein:
the controller is configured to control the operating state of the regenerative braking of the vehicle based on one or more road traffic conditions ahead of the vehicle.

14. The driving control device according to claim 13, wherein:
the controller is configured to control the operating state of the regenerative braking of the vehicle based on, as the one or more road traffic conditions, at least one of (i) a lighting state of one or more traffic lights located ahead of the vehicle and (ii) a change timing of each of the traffic lights located ahead of the vehicle.

15. The driving control device according to claim 1, wherein:
the controller is configured to change an inter-vehicle distance between the vehicle and a preceding vehicle in inter-vehicle distance control in accordance with at least one of a position and the motion of the target foot of the driver.

16. The driving control device according to claim 1, wherein:
the target foot of the driver is a right foot thereof.

17. A vehicular system to be installed in a vehicle, the vehicular system comprising:
a contactless foot motion sensor mounted to the vehicle and configured to output sensor information indicative of a motion of a target foot of a driver of the vehicle; and
the driving control device according to claim 1, wherein the contactless sensor according to claim 1 is the contactless foot motion sensor.
